(19) United States
(12) Patent Application Publication
(10) Pub. No.: US 2017/0214949 A1
(43) Pub. Date: Jul. 27, 2017

(54) GUIDELINE-BASED VIDEO CLASSIFICATION OF DATA STREAMS

(71) Applicant: International Business Machines Corporation, Armonk, NY (US)

(72) Inventors: Karen Avetisyan, Dublin (IE); Dmitry Simakov, Dublin (IE)

(21) Appl. No.: 15/007,271

(22) Filed: Jan. 27, 2016

(51) Int. Cl. H04N 21/234; H04N 21/235; H04N 21/25; H04N 21/2665

(52) U.S. Cl. CPC H04N 21/23418; H04N 21/2665; H04N 21/2353; H04N 21/251

(57) ABSTRACT

A computer-implemented method includes identifying a data stream and identifying one or more video classification circumstantial guidelines. The computer-implemented method further includes determining whether the data stream satisfies at least one of the one or more video classification circumstantial guidelines. A corresponding computer program product and computer system are also disclosed.

### BACKGROUND

The present invention relates generally to the field of data stream analysis, and more particularly to classification of data streams as video streams.

Classifying data streams as video streams is an important step in properly processing and managing the transmission of such video streams. Developers of networking systems continue to face challenges with costs incurred as a result of inaccurate video classifications of data streams.

### SUMMARY

A computer-implemented method includes identifying a data stream and identifying one or more video classification circumstantial guidelines. The computer-implemented method further includes determining whether the data stream satisfies at least one of the one or more video classification circumstantial guidelines. A corresponding computer program product and computer system are also disclosed.

### BRIEF DESCRIPTION OF THE DRAWINGS

FIG. 1 is a block diagram of one embodiment of a computer system environment suitable for operation of a video classification program, in accordance with at least one embodiment of the present invention.

FIG. 2 is a flow-chart diagram of a video classification program, in accordance with at least one embodiment of the present invention.

FIGS. 3A, 3B, 3C, and 3D depict data for data stream circumstantial properties associated with four data streams, in accordance with at least one embodiment of the present invention.

FIG. 4 is an operational example of a Boolean video classification circumstantial guideline, in accordance with at least one embodiment of the present invention.

FIG. 5 depicts data for a recommendation table, in accordance with at least one embodiment of the present invention.

FIG. 6 is a block diagram of a computing apparatus suitable for executing a video classification program, in accordance with at least one embodiment of the present invention.

### DETAILED DESCRIPTION

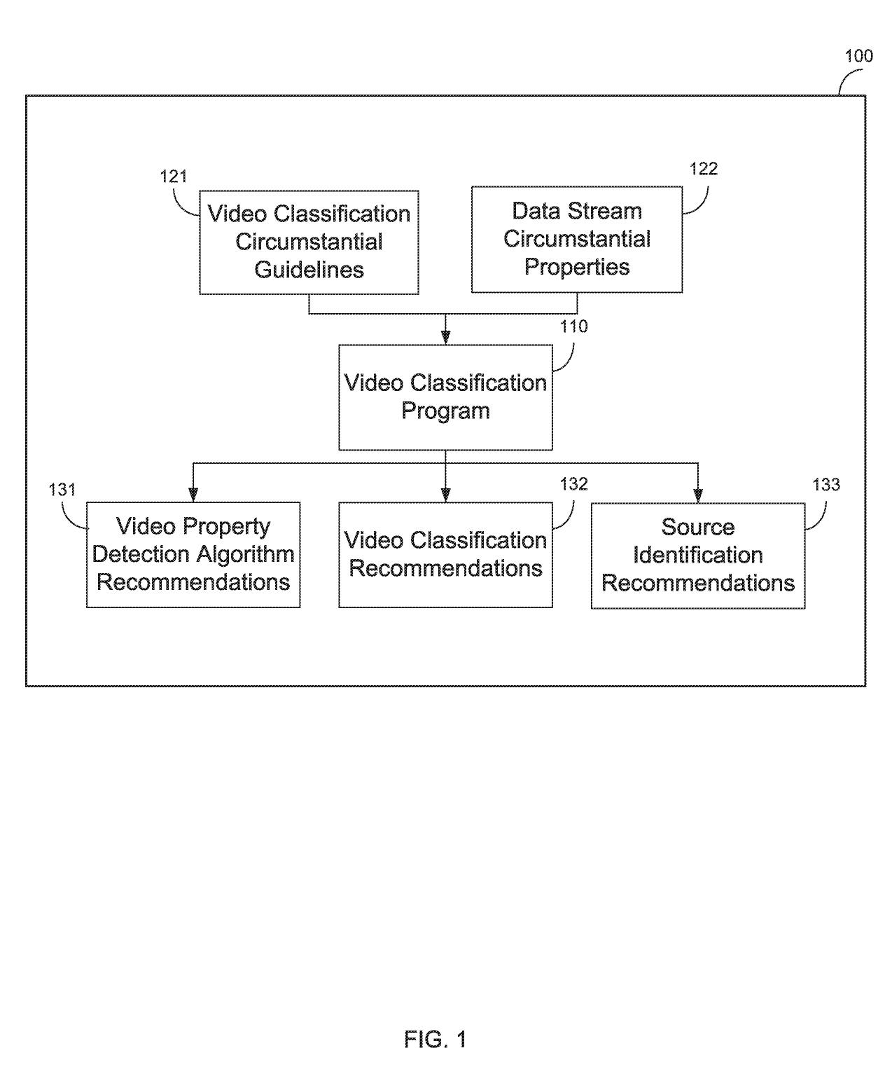

FIG. 1 is a block diagram of a computer system environment 100 suitable for operating a video classification program 110, in accordance with at least one embodiment of the present invention. In the computer system environment 100 depicted in FIG. 1, a data stream is any sequence of one or more units of data (e.g., data packets), where the sequence of one or more units of data may be transmitted over one or more abstraction layers (such as an application layer) in a network layering model (such as the Open Systems Interconnection model). In at least some embodiments, a video classification circumstantial guideline 121 is any one or more information artefacts that, in whole or in part and directly or indirectly, can be used to classify a data stream as a video stream (e.g., with a predefined level of certainty, such as 100% certainty) based on one or more properties associated with the data stream other than the contents of the payload of the data stream (i.e., one or more “circumstantial properties” 122 associated with the data stream). In at least some embodiments, one or more video classification circumstantial guidelines comprise one or more Boolean rules about what data streams should be classified as a video stream (i.e., one or more “Boolean video classification circumstantial guidelines”).

In the computer system environment 100 depicted in FIG. 1, the video classification program 110 uses the one or more video classification circumstantial guidelines 121 and the one or more data stream circumstantial properties 122 to determine one or more video classification recommendations 132, one or more video detection algorithm recommendations 131, and one or more source identification recommendations 133.

In at least some embodiments, a video property detection algorithm recommendation 131 is any information artefact that, in whole or in part and directly or indirectly, requires, suggests, and/or recommends that (e.g., with a predefined level of certainty, such as 75% certainty) at least one data stream (e.g., at least one video stream) undergo at least one algorithm intended to, under successful and regular executions, extract at least one property associated with the data stream (such as at least one public key infrastructure property associated with the at least one data stream and/or associated with the execution and/or rendering of the at least one data stream). In at least some embodiments, a video classification recommendation 132 is any information artefact that, in whole or in part and directly or indirectly, requires, suggests, and/or recommends that (e.g., with a predefined level of certainty, such as 65% certainty) at least one data stream be classified and/or treated as a video stream (e.g., a video stream of one or more formats). In at least some embodiments, a source identification recommendation 133 is any information artefact that, in whole or in part and directly or indirectly, comprises an estimation (e.g., with a predefined level of certainty, such as 80% certainty) of one or more likely or definite sources (e.g., one or more host servers) and/or one or more likely or definite categories of sources associated with at least one data stream (e.g., at least one video stream).

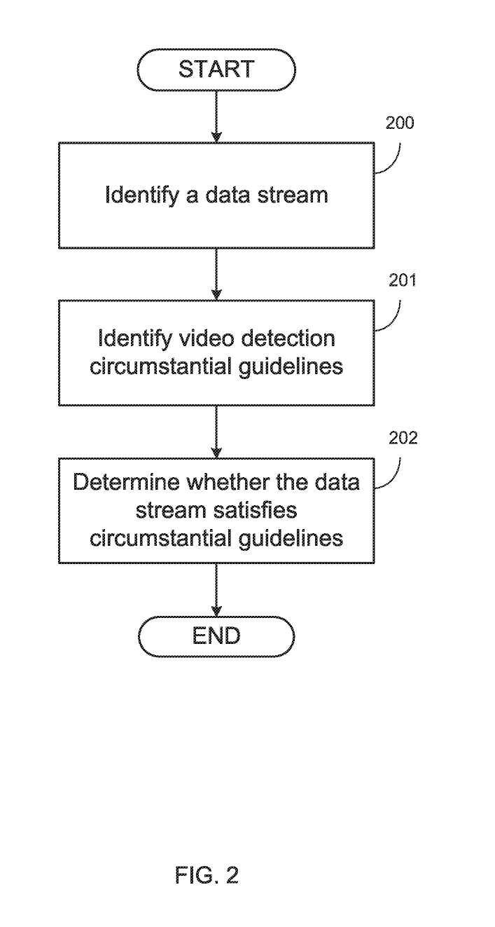

FIG. 2 is a flow-chart diagram of a video classification program, in accordance with at least one embodiment of the present invention. At step 201, the program identifies a data stream. At step 202, the program identifies one or more video classification circumstantial guidelines. At step 203, the program determines whether the data stream satisfies at least one of the one or more video detection guidelines.

In some embodiments, the video classification program determines one or more recommendations selected from the group consisting of: (i) one or more video classification recommendations; (ii) one or more video property detection algorithm recommendations; and (iii) one or more source identification recommendations. In some embodiments, the program identifies one or more data stream circumstantial properties associated with the data stream, and determining whether the data stream satisfies at least one of the one or more video classification circumstantial guidelines comprises determining whether the one or more data circumstantial properties satisfy the one or more video classification circumstantial guidelines.

In some embodiments, the one or more data stream circumstantial properties comprise one or more properties selected from the group consisting of: (i) one or more server-based properties; (ii) one or more client-based properties; and (iii) one or more path-based properties. In at least some embodiments, a server-based property is any property that, in whole or in part and directly or indirectly, is associated with at least one server computer (such as the location, one or more hardware qualities, the server management software, the database management software, processor speed, the storage capability, and the ping response time of at least one server computer). In at least some embodiments, a client-based property is any property that, in whole or in part and directly or indirectly, is associated with at least one client computer (such as the location, one or more hardware qualities, processor speed, and storage capability, the operating system, the network connection type, and the ping response time of at least one client computer). In at least some embodiments, a path-based property is any property that, in whole or in part and directly or indirectly, denotes and/or comprises at least one information artefact about how at least one data stream is accessed by client (e.g., the access path that the client took to reach the data stream, such as the URL through which the client reached the data stream, or the website platform through which the user was redirected to the data stream) and/or could be accessed by a client during successful and regular executions. In at least some embodiment, a computer processor's speed refers to the frequency at which the computer processor executes instructions.

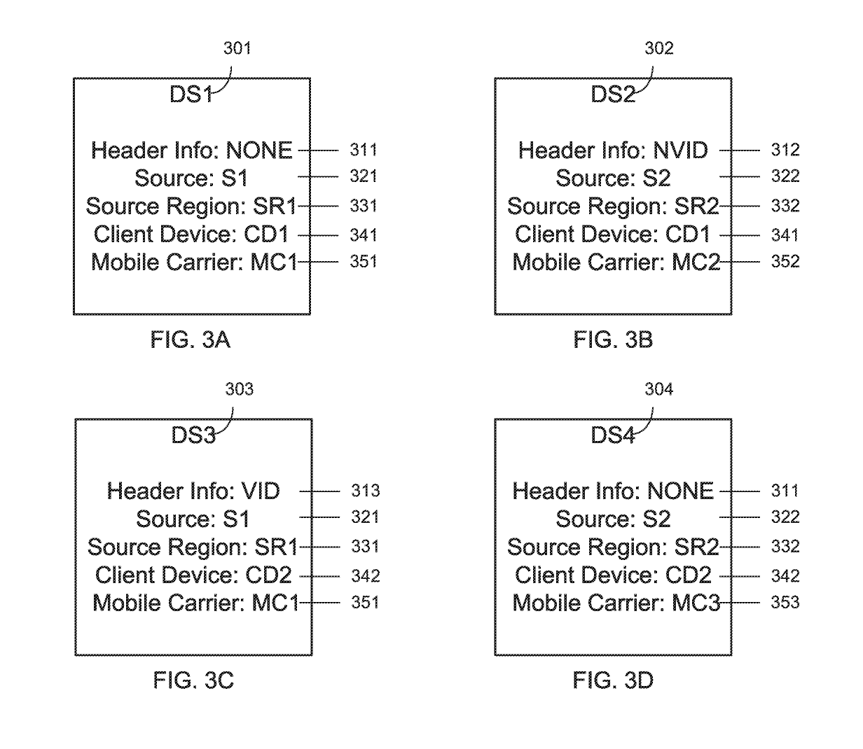

FIGS. 3A, 3B, 3C, and 3D depict data for data stream circumstantial properties associated with four data streams, in accordance with at least one embodiment of the present invention. In the embodiment depicted in FIG. 3A, data stream DS1 301 has a header comprising the information artefact “NONE” 311 (i.e., denoting absence of any video classification information), is from the source S1 321 from the source region SR1 331, and is transmitted to a client device of type CD1 341 operating on a mobile carrier of type MC1 351. In the embodiment depicted in FIG. 3B, data stream DS2 302 has a header comprising the information artefact “NVID” 312 (i.e., denoting that the data stream is not a video), is from the source S2 322 from the source region SR2 332, and is transmitted to a client device of type CD1 341 operating on a mobile carrier of type MC2 352. In the embodiment depicted in FIG. 3C, data stream DS3 303 has a header comprising the information artefact “VID” 313 (i.e., denoting that the data stream is a video), is from the source S1 321 from the source region SR1 331, and is transmitted to a client device of type CD2 342 operating on a mobile carrier of type MC1 351. In the embodiment depicted in FIG. 3D, data stream DS4 304 has a header comprising the information artefact “NONE” 311, is from the source S2 322 from the source region SR2 332, and is transmitted to a client device of type CD2 342 operating on a mobile carrier of type MC3 353.

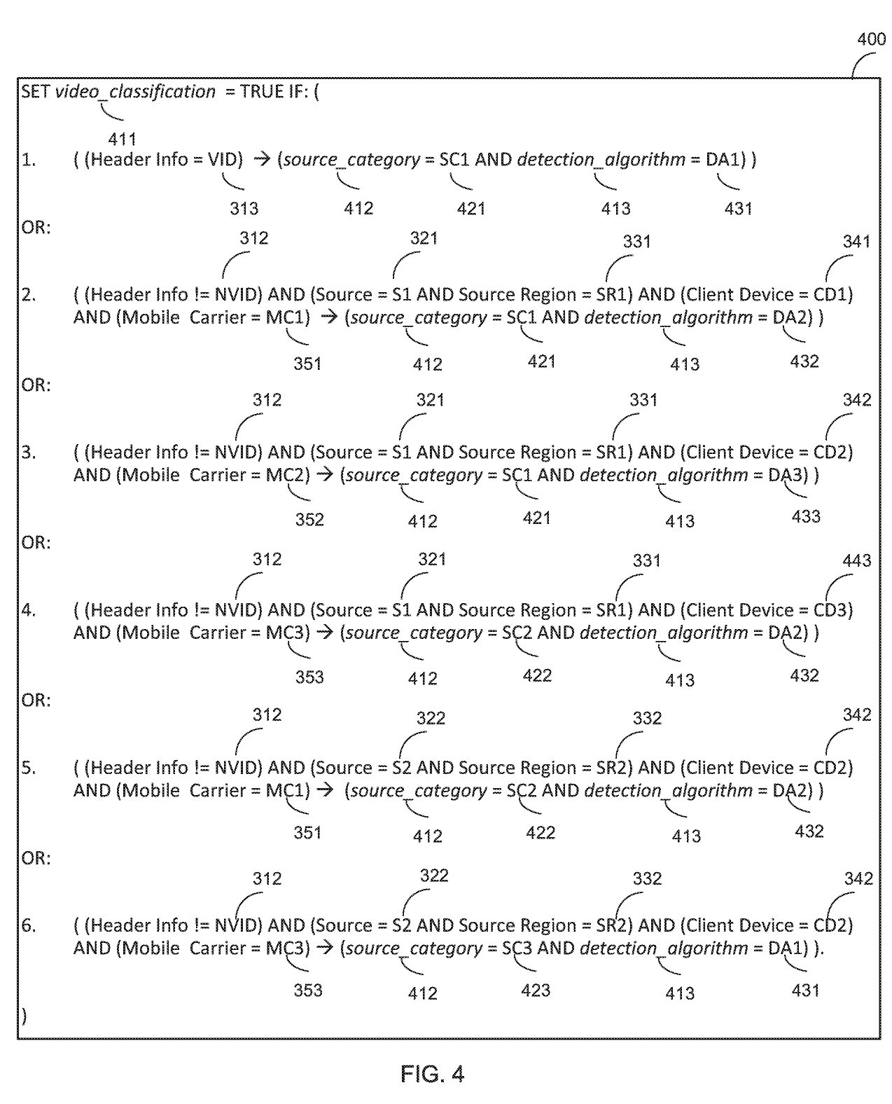

FIG. 4 is an operational example of a Boolean video classification circumstantial guideline 400, in accordance with at least one embodiment of the present invention. In the Boolean video classification circumstantial guideline 400 depicted in FIG. 4, the terms “AND” and “OR” represent Boolean operators ̂ and I (where Boolean expression A1̂A2̂ . . . ̂ An returns 1 or TRUE if A1, A2, . . . , An are all true and where A1|A2| . . . | An returns 1 or TRUE if at least one of A1, A2, . . . , An returns 1 or TRUE). The video classification guideline depicted in FIG. 4 contains six Boolean expressions separated by the Boolean OR operator, and therefore returns TRUE if at least one of the six Boolean expressions are correct. If the Boolean video classification circumstantial guideline 400 returns true, then the value of variable video_classification 411 associated with a data stream (denoting a video classification recommendation for the data stream) is set to TRUE, indicating the requirement, recommendation, and/or suggestion that the data stream should be classified as a video stream. In some embodiments, the entirety of the Boolean video classification circumstantial guideline 400 is guaranteed to be executed in the numeric order in all successful and regular executions of the Boolean video classification circumstantial guideline 400; in some other embodiments, during successful and regular executions of the Boolean video classification circumstantial guideline 400, the six Boolean expressions may be executed in different orders and, upon one Boolean expression returning TRUE, the remaining unexecuted Boolean expressions will not be executed.

In the Boolean video classification circumstantial guideline 400 depicted in FIG. 4, each Boolean expression is followed by the □ operator and one or more assignments. The one or more assignments immediately following the □ will, during all successful and regular executions of the Boolean video classification circumstantial guideline 400, always be executed if the Boolean expression immediately preceding the □ operator returns TRUE. Boolean expression 1 returns TRUE if a data stream has a header comprising the information artefact “VID” 313; if Boolean expression 1 is TRUE, then the variable source_category 412 (denoting a source identification recommendation for the data stream) is set to denote source identification recommendation SC1 421 and the variable detection_algorithm 413 (denoting a video property detection algorithm recommendation for the data stream) is set to denote video property detection algorithm recommendation DA1 431. Boolean expression 2 returns TRUE if a data stream has a header that does not comprise the information artefact “NVID” 312, is from the source S1 321 from the source region SR1 331, and is transmitted to a client device of type CD1 341 operating on a mobile carrier of type MC1 351; if Boolean expression 2 is TRUE, then the variable source_category 412 is set to denote source identification recommendation SC1 421 and the variable detection_algorithm 413 is set to denote video property detection algorithm recommendation DA2 432.

In the Boolean video classification circumstantial guideline 400 depicted in FIG. 4, Boolean expression 3 returns TRUE if a data stream has a header that does not comprise the information artefact “NVID” 312, is from the source S1 321 from the source region SR1 331, and is transmitted to a client device of type CD2 342 operating on a mobile carrier of type MC2 352; if Boolean expression 3 is TRUE, then the variable source_category 412 is set to denote source identification recommendation SC1 421 and the variable detection_algorithm 413 is set to denote video property detection algorithm recommendation DA3 433. Boolean expression 4 returns TRUE if a data stream has a header that does not comprise the information artefact “NVID” 312, is from the source S1 321 from the source region SR1 331, and is transmitted to a client device of type CD3 443 operating on a mobile carrier of type MC3 353; if Boolean expression 4 is TRUE, then the variable source_category 412 is set to denote source identification recommendation SC2 422 and the variable detection_algorithm 413 is set to denote video property detection algorithm recommendation DA2 432.

In the Boolean video classification circumstantial guideline 400 depicted in FIG. 4, Boolean expression 5 returns TRUE if a data stream has a header that does not comprise the information artefact “NVID” 312, is from the source S2 322 from the source region SR2 332, and is transmitted to a client device of type CD2 342 operating on a mobile carrier of type MC1 351; if Boolean expression 5 is TRUE, then the variable source_category 412 is set to denote source identification recommendation SC2 422 and the variable detection_algorithm 413 is set to denote video property detection_algorithm recommendation DA2 432. Boolean expression 6 returns TRUE if a data stream has a header that does not comprise the information artefact “NVID” 312, is from the source S2 322 from the source region SR2 332, and is transmitted to a client device of type CD2 342 operating on a mobile carrier of type MC3 353; if Boolean expression 6 is TRUE, then the variable source_category 412 is set to denote source identification recommendation SC3 423 and the variable detection_algorithm 413 is set to denote video property detection algorithm recommendation DA2 431.

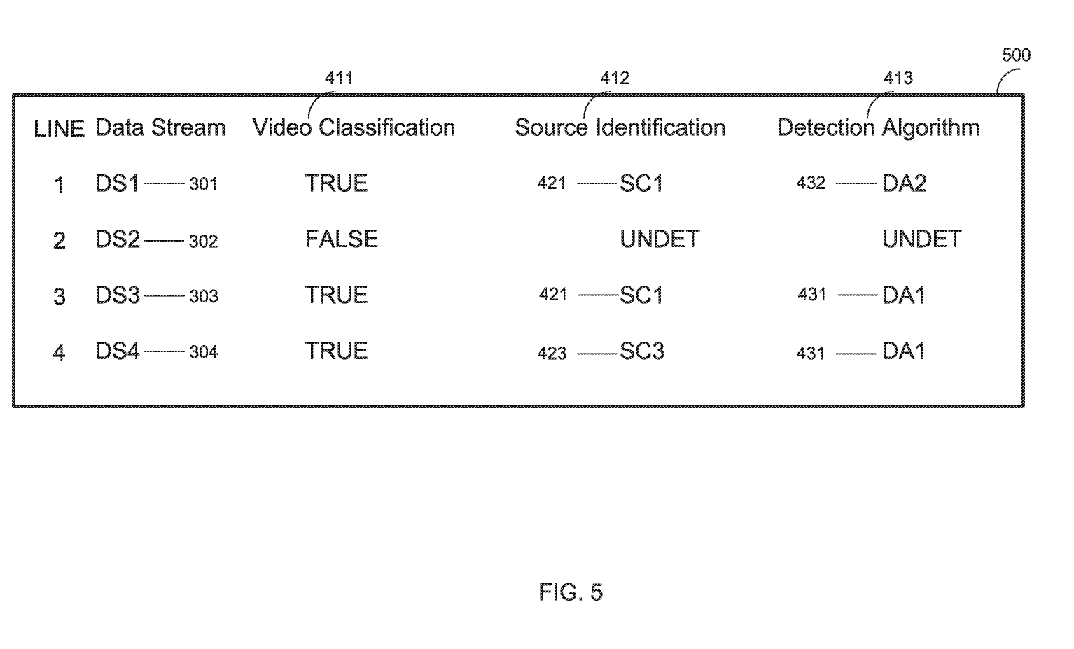

FIG. 5 depicts data for a recommendation table 500, in accordance with at least one embodiment of the present invention. The recommendation table 500 depicted in FIG. 5 comprises a video classification recommendation 411 for each data stream identified in FIG. 4 as well a source identification recommendation 412 and a video property detection algorithm recommendation 413 for each data stream with an associated video classification recommendation noted as “TRUE” (i.e., denoting a requirement, suggestion, and/or recommendation that the data stream be classified and/or treated as a video stream). The recommendation table 500 depicted in FIG. 5 is calculated based on the data stream circumstantial properties depicted in FIGS. 3A, 3B, 3C, and 3D as well as the Boolean video classification circumstantial guideline 400 depicted in in FIG. 4. In some embodiments, the video classification program determines at least one of source identification recommendations 412 or video detection property algorithm recommendations 413 even for one or more data streams with associated video classification recommendations not noted as “TRUE.”

In the recommendation table 500 depicted in FIG. 5, line 1 notes that DS1 301 (whose properties satisfy Boolean expression 2 in the Boolean video classification circumstantial guideline 400 depicted in FIG. 4) is associated with a video classification recommendation 411 noted as “TRUE,” a source identification recommendation 412 SC1 421, and a video property detection algorithm recommendation 413 DA2 432. Line 2 notes that data stream DS2 302 (whose properties do not satisfy any Boolean expression in the Boolean video classification circumstantial guideline 400 depicted in FIG. 4) is associated with a video classification recommendation 411 noted as “FALSE” (i.e., denoting a requirement, suggestion, and/or recommendation that the data stream not be classified and/or treated as a video stream) and a source identification recommendation 412 and a video property detection algorithm 413 noted as “UNDET” (i.e., denoting that those recommendations have not been determined by the video classification program).

In the recommendation table 500 depicted in FIG. 5, line 3 notes that data stream DS3 303 (whose properties satisfy Boolean expression 1 in the Boolean video classification circumstantial guideline 400 depicted in FIG. 4) is associated with a video classification recommendation 411 noted as “TRUE,” a source identification recommendation 412 SC1 421, and a video property detection algorithm recommendation 413 DA1 431. Line 4 notes that data stream DS4 304 (whose properties satisfy Boolean expression 6 in the Boolean video classification circumstantial guideline 400 depicted in FIG. 4) is associated with a video classification recommendation 411 noted as “TRUE,” a source identification recommendation 412 SC3 423, and a video property detection algorithm recommendation 413 DA1 431.

In some embodiments, the data stream is transmitted through at least one data transition medium, wherein the at least one data transition medium comprises one or more data transition tunnels selected from the group consisting of: (i) one or more point to point tunneling protocol tunnels; (ii) one or more layer two tunnel protocol tunnels; (iii) one or more internet protocol security tunnels; (iv) one or more generic routing encapsulation tunnels; and (iv) one or more general packet radio service tunneling protocol tunnels. In some embodiments, the one or more video classification circumstantial guidelines comprise one or more guidelines specified in extensible markup language (XML). In some embodiments, the data stream comprises one or more application layer packets.

In general, one or more steps of different embodiments of the client-based instrumentation program may be performed based on one or more pieces of information obtained directly or indirectly from one or more computer (hardware or software) components, one or more pieces of information obtained directly or indirectly from one or more inputs from one or more users, and/or one or more observed behaviors associated with one or more (hardware or software) components of one or more computer system environments. In general, one or more steps of different embodiments of the client-based instrumentation program may comprise communicating with one or more computer (hardware or software) components, issuing one or more computer instructions (e.g., one or more special purpose machine-level instructions defined in the instruction set of one or more computer hardware components), and/or communicating with one or more computer components at the hardware level.

Aspects of the present invention allow for video classification of data streams without the need for incurring costly analysis of the contents of the data stream payload or resorting to costly machine learning algorithms. In addition, aspects of the present invention allow for video classification based on guidelines supplied by one or more computer (hardware or software) components and/or one or more users, and thus reduce the need for resorting to pre-defined, rigid rules that may lose their predictive capability over time. Nevertheless, the aforementioned advantages are not required to be present in all of the embodiments of the invention and may not be present in all of the embodiments of the invention.

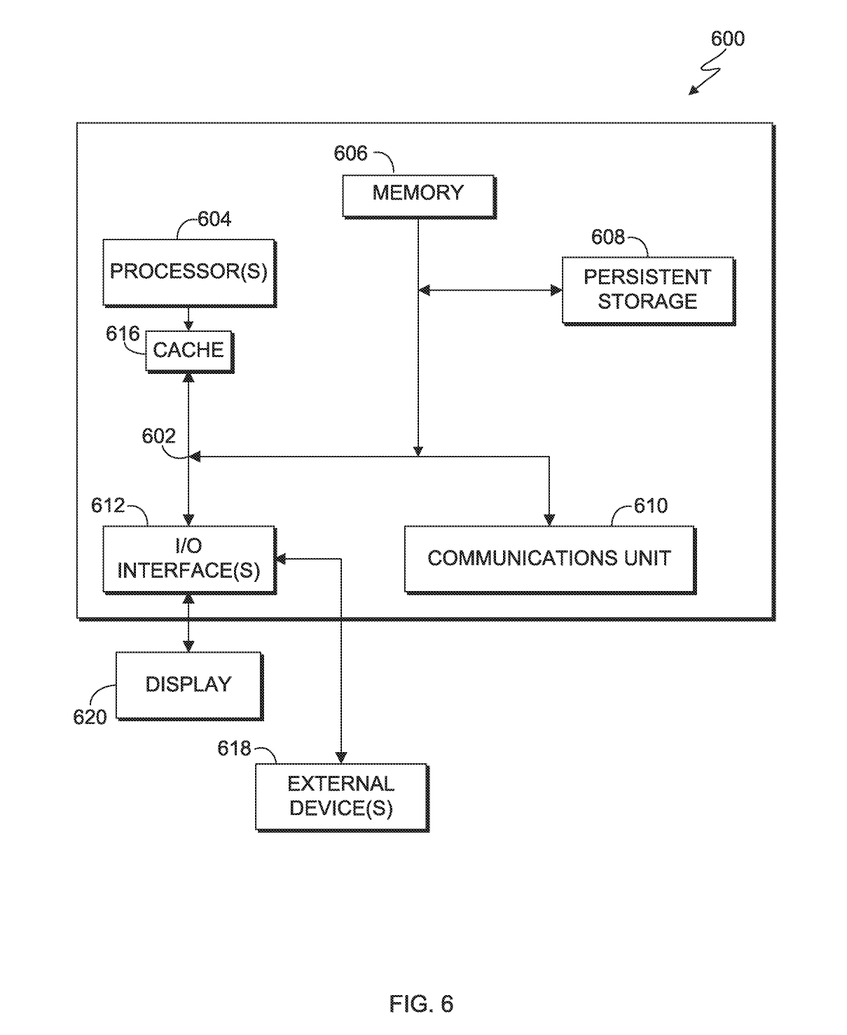

FIG. 6 is a block diagram depicting components of a computer 600 suitable for executing the video classification program. FIG. 6 displays the computer 600, the one or more processor(s) 604 (including one or more computer processors), the communications fabric 602, the memory 606, the RAM, the cache 616, the persistent storage 608, the communications unit 610, the I/O interfaces 612, the display 620, and the external devices 618. It should be appreciated that FIG. 6 provides only an illustration of one embodiment and does not imply any limitations with regard to the environments in which different embodiments may be implemented. Many modifications to the depicted environment may be made.

As depicted, the computer 600 operates over a communications fabric 602, which provides communications between the cache 616, the computer processor(s) 604, the memory 606, the persistent storage 608, the communications unit 610, and the input/output (I/O) interface(s) 612. The communications fabric 602 may be implemented with any architecture suitable for passing data and/or control information between the processors 604 (e.g., microprocessors, communications processors, and network processors, etc.), the memory 606, the external devices 618, and any other hardware components within a system. For example, the communications fabric 602 may be implemented with one or more buses or a crossbar switch.

The memory 606 and persistent storage 608 are computer readable storage media. In the depicted embodiment, the memory 606 includes a random access memory (RAM). In general, the memory 606 may include any suitable volatile or non-volatile implementations of one or more computer readable storage media. The cache 616 is a fast memory that enhances the performance of computer processor(s) 604 by holding recently accessed data, and data near accessed data, from memory 606.

Program instructions for the video classification program may be stored in the persistent storage 608 or in memory 606, or more generally, any computer readable storage media, for execution by one or more of the respective computer processors 604 via the cache 616. The persistent storage 608 may include a magnetic hard disk drive. Alternatively, or in addition to a magnetic hard disk drive, the persistent storage 608 may include, a solid state hard disk drive, a semiconductor storage device, read-only memory (ROM), electronically erasable programmable read-only memory (EEPROM), flash memory, or any other computer readable storage media that is capable of storing program instructions or digital information.

The media used by the persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of the persistent storage 608.

The communications unit 610, in these examples, provides for communications with other data processing systems or devices. In these examples, the communications unit 610 may include one or more network interface cards. The communications unit 610 may provide communications through the use of either or both physical and wireless communications links. The video classification program may be downloaded to the persistent storage 608 through the communications unit 610. In the context of some embodiments of the present invention, the source of the various input data may be physically remote to the computer 600 such that the input data may be received and the output similarly transmitted via the communications unit 610.

The I/O interface(s) 612 allows for input and output of data with other devices that may operate in conjunction with the computer 600. For example, the I/O interface 612 may provide a connection to the external devices 618, which may include a keyboard, keypad, a touch screen, and/or some other suitable input devices. External devices 618 may also include portable computer readable storage media, for example, thumb drives, portable optical or magnetic disks, and memory cards. Software and data used to practice embodiments of the present invention may be stored on such portable computer readable storage media and may be loaded onto the persistent storage 608 via the I/O interface(s) 612. The I/O interface(s) 612 may similarly connect to a display 620. The display 620 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
identifying a data stream;
identifying one or more video classification circumstantial guidelines; and
determining whether said data stream satisfies at least one of said one or more video classification circumstantial guidelines.

2. The computer-implemented method of claim 1, further comprising:
determining one or more recommendations selected from the group consisting of:
one or more video classification recommendations;
one or more video property detection_algorithm recommendations; and
one or more source identification recommendations.

3. The computer-implemented method of claim 1, wherein said data stream is transmitted through at least one data transition medium, said at least one data transition medium comprising one or more data transition tunnels selected from the group consisting of:
one or more point to point tunneling protocol tunnels;
one or more layer two tunnel protocol tunnels;
one or more internet protocol security tunnels;
one or more generic routing encapsulation tunnels; and
one or more general packet radio service tunneling protocol tunnels.

4. The computer-implemented method of claim 1, wherein said one or more video classification circumstantial guidelines comprise one or more guidelines specified in extensible markup language.

5. The computer-implemented method of claim 1, wherein said data stream comprises one or more application layer packets.

6. The computer-implemented method of claim 1, further comprising:
identifying one or more data stream circumstantial properties, said one or more data stream circumstantial properties being associated with said data stream; and, wherein:
determining whether said data stream satisfies at least one of said one or more video classification circumstantial guidelines comprises determining whether said one or more data stream circumstantial properties satisfy said one or more video classification circumstantial guidelines.

7. The computer-implemented method of claim 6, wherein said one or more data stream circumstantial properties comprise one or more properties selected from the group consisting of:
one or more server-based properties;
one or more client-based properties; and
one or more path-based properties.

8. A computer program product, comprising one or more computer readable storage media and program instructions stored on said one or more computer readable storage media, said program instructions comprising instructions to:
identify a data stream;
identify one or more video classification circumstantial guidelines; and
determine whether said data stream satisfies at least one of said one or more video classification circumstantial guidelines.

9. The computer program product of claim 8, wherein said program instructions further comprise instructions to:
determine one or more recommendations selected from the group consisting of:
one or more video classification recommendations;
one or more video property detection algorithm recommendations; and
one or more source identification recommendations.

10. The computer program product of claim 8, wherein said data stream is transmitted through at least one data transition medium, said at least one data transition medium comprising one or more data transition tunnels selected from the group consisting of:
one or more point to point tunneling protocol tunnels;
one or more layer two tunnel protocol tunnels;
one or more internet protocol security tunnels;
one or more generic routing encapsulation tunnels; and
one or more general packet radio service tunneling protocol tunnels.

11. The computer program product of claim 8, wherein said one or more video classification circumstantial guidelines comprise one or more guidelines specified in extensible markup language.

12. The computer program product of claim 8, wherein said data stream comprises one or more application layer packets.

13. The computer program product of claim 8, wherein:
said program instructions further comprise instructions to identify one or more data stream circumstantial properties, said one or more data stream circumstantial properties being associated with said data stream; and
said instructions to determine whether said data stream satisfies at least one of said one or more video classification circumstantial guidelines further comprise instructions to determine whether said one or more data stream circumstantial properties satisfy said one or more video classification circumstantial guidelines.

14. The computer program product of claim 13, wherein said one or more data stream circumstantial properties comprise one or more properties selected from the group consisting of:
one or more server-based properties;
one or more client-based properties; and
one or more path-based properties.

15. A computer system comprising:
a processor;
one or more computer readable storage media;
computer program instructions;
said computer program instructions being stored on said one or more computer readable storage media; and
said computer program instructions comprising instructions to:
identify a data stream;
identify one or more video classification circumstantial guidelines; and
determine whether said data stream satisfies at least one of said one or more video classification circumstantial guidelines.

16. The computer system of claim 15, wherein said computer program instructions further comprise instructions to:
determine one or more recommendations selected from the group consisting of:
one or more video classification recommendations;
one or more video property detection algorithm recommendations; and
one or more source identification recommendations.

17. The computer system of claim 15, wherein said data stream is transmitted through at least one data transition medium, said at least one data transition medium comprising one or more data transition tunnels selected from the group consisting of:
one or more point to point tunneling protocol tunnels;
one or more layer two tunnel protocol tunnels;
one or more internet protocol security tunnels;
one or more generic routing encapsulation tunnels; and
one or more general packet radio service tunneling protocol tunnels.

18. The computer system of claim 15, wherein said data stream comprises one or more application layer packets.

19. The computer system of claim 15, wherein:
said computer program instructions further comprise instructions to identify one or more data stream circumstantial properties, said one or more data stream circumstantial properties being associated with said data stream; and
said instructions to determine whether said data stream satisfies at least one of said one or more video classification circumstantial guidelines further comprise instructions to determine whether said one or more data stream circumstantial properties satisfy said one or more video classification circumstantial guidelines.

20. The computer system of claim 19, wherein said one or more data stream circumstantial properties comprise one or more properties selected from the group consisting of:
one or more server-based properties;
one or more client-based properties; and
one or more path-based properties.
